(19) United States
(12) Patent Application Publication
(10) Pub. No.: US 2019/0284869 A1
(43) Pub. Date: Sep. 19, 2019

(54) MAGNETIC ADJUSTABLE LOUVERED SHUTTERS

(71) Applicant: Howard Dawson, Cape Coral, FL (US)

(72) Inventor: Howard Dawson, Cape Coral, FL (US)

(21) Appl. No.: 15/980,147

(22) Filed: May 15, 2018

Related U.S. Application Data
(60) Provisional application No. 62/644,963, filed on Mar. 19, 2018.

(51) Int. Cl. E06B 7/086

(52) U.S. Cl. CPC E06B 7/086

(57) ABSTRACT

Adjustable louvered shutters having a magnetic coupling between the adjustment rod and individual louvers are disclosed. An adjustable louvered shutter may include a frame that defines a shutter plane, a plurality of louvers coupled for pivotal movement relative to the frame and each having a louver magnetic coupling element, and a louver adjustment rod that includes at least one rod magnetic coupling element that is magnetically coupled to the louver magnetic coupling elements of the plurality of louvers. The magnetic coupling between a louver magnetic coupling element and a rod magnetic coupling element is configured to synchronously pivot each the louvers about their respective pivot axes in response to a translation of the louver adjustment rod.

### RELATED APPLICATION

This application claims priority under 35 U.S.C. § 119(e) to U.S. Provisional Patent Application Ser. No. 62/644,963, which was filed on Mar. 19, 2018, and the complete disclosure of which is hereby incorporated by reference.

### FIELD The present disclosure relates generally to the field of shutters, and more particularly to the field of louvered shutters with adjustable louvers.

### BACKGROUND

Louvered shutters are shutters in which a plurality of louvers, or “slats,” are pivotal relative to a shutter frame to enable a user to control the amount of light and/or airflow that passes through the shutters. With many conventional louvered shutters, an adjustment rod interconnects the plurality of louvers so that forces imparted to the rod cause a synchronized pivoting of all of the louvers relative to the frame. Conventionally, to achieve this synchronized pivoting, adjustment rods are mechanically attached (e.g., with staples) to each louver in the shutter. It is this mechanical interconnection that has traditionally enabled the forces imparted on the adjustment rod to be converted into synchronous pivotal rotation of the louvers. However, such conventional attachment is not ideal, as the current processes for mechanically coupling individual louvers to the adjustment rod are time-consuming and/or require use of specialized coupling tools.

Moreover, because the mechanical couplings between the adjustment rod and the louvers are subject to a mechanical stress each time a user translates the adjustment rod, these mechanical couplings are vulnerable breaking points in conventional louvered shutters. This is problematic for shutter owners since, once a coupling mechanism between an adjustment rod and a corresponding louver is broken, the corresponding louver is no longer pivotally adjusted by the adjustment rod. This means that a louver with a broken mechanical coupling has to he adjusted by hand and/or may not remain in a selected pivotal orientation. To make things worse, since the mechanical couplings are often located on hidden surfaces to protect the ascetic simplicity of the louvered shutters, fixing and/or replacing broken mechanical couplings often is difficult.

### SUMMARY

Adjustable louvered shutters having a magnetic coupling between the adjustment rod and individual louvers are disclosed herein. An adjustable louvered shutter according to the present disclosure includes a frame that defines a shutter plane, a plurality of louvers coupled for pivotal movement relative to the frame and each having a louver magnetic coupling element, and an adjustment rod that includes at least one rod magnetic coupling element that is magnetically coupled to the louver magnetic coupling elements of the plurality of louvers. The magnetic coupling between a louver magnetic coupling element and the rod magnetic coupling element is configured to utilize the translational forces imparted to the adjustment rod to cause a corresponding pivoting of the plurality of louvers about their respective pivot axes. The disclosed adjustable louvered shutters are configured to selectively transition between a closed orientation and an open orientation by rotating the louvers about their respective pivot axes.

### BRIEF DESCRIPTION OF THE DRAWINGS

FIG. 1 is an exploded perspective view illustrating schematic examples of an adjustable louvered shutter in an open orientation according to the present disclosure.

FIG. 2 is an exploded perspective view of the shutter of FIG. 1 in a closed orientation.

FIG. 3 is an exploded fragmentary side perspective view illustrating an example of the magnetic coupling of the louver adjustment rod to an individual louver according to the present disclosure.

FIG. 4 is an exploded side perspective view illustrating the magnetic coupling of FIG. 3 in a first pivot position.

FIG. 5 is an exploded side perspective view illustrating the magnetic coupling of FIG. 3 in a second pivot position.

FIG. 6 is an exploded side perspective view illustrating the magnetic coupling of FIG. 3 in a third pivot position.

FIG. 7 is a fragmentary cross-sectional side elevation view of an example of a coupling element according to the present disclosure having a socket rod magnetic coupling element and a convex louver magnetic coupling element.

FIG. 8 is a fragmentary cross-sectional side elevation view of an example of a coupling element according to the present disclosure having a socket rod magnetic coupling element and a ball louver magnetic coupling element.

FIG. 9 is a top plan view of an example of a louver according to the present disclosure having an attached magnetic coupling element on a front region.

FIG. 10 is a top plan view of an example of a louver according to the present disclosure having an attached magnetic coupling element on a side region.

FIG. 11 is a top plan view of an example of a louver according to the present disclosure having an embedded magnetic coupling element in a front region.

FIG. 12 is a top plan view of an example of a louver according to the present disclosure having an embedded magnetic coupling element in a side region.

FIG. 13 is a top plan view of an example of a louver according to the present disclosure having an elongated magnetic coupling element.

FIG. 14 is a top plan view of an example of a louver according to the present disclosure having an elongated magnetic coupling element and recesses.

FIG. 15 is a fragmentary cross-sectional side elevation view of an example of a louver adjustment rod having multiple attached magnetic coupling elements.

FIG. 16 is a fragmentary cross-sectional side elevation view of an example of a louver adjustment rod having multiple embedded magnetic coupling elements.

FIG. 17 is a fragmentary cross-sectional side elevation view of an example of a louver adjustment rod having multiple magnetic coupling elements and recesses.

FIG. 18 is a fragmentary cross-sectional side elevation view of an example of a louver adjustment rod having an elongated magnetic coupling element.

FIG. 19 is a fragmentary cross-sectional side elevation view of an example of a louver adjustment rod that comprises a single magnetic coupling element.

FIG. 20 is a fragmentary cross-sectional side elevation view of an example of a louver adjustment rod that comprises a single magnetic coupling element and has multiple recesses.

FIG. 21 is a fragmentary cross-sectional side elevation view of an example of a coupling element according to the present disclosure having a socket rod mechanical coupling element and a ball louver mechanical coupling element.

FIG. 22 is a perspective view illustrating an example of a socket rod mechanical coupling element according to the present disclosure.

### DETAILED DESCRIPTION

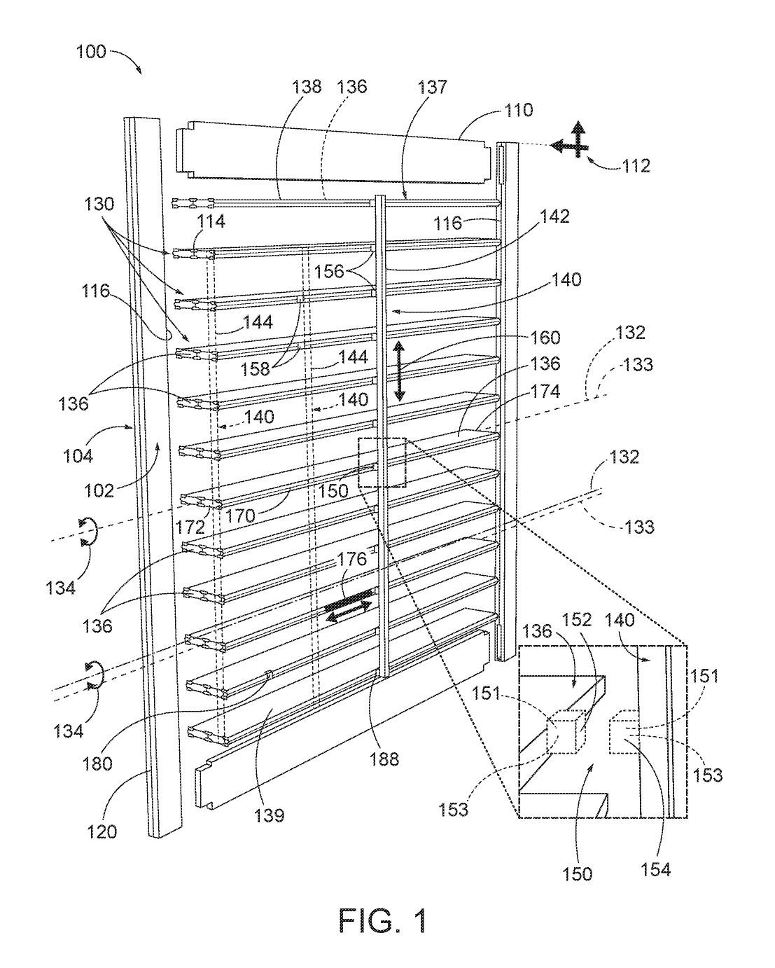

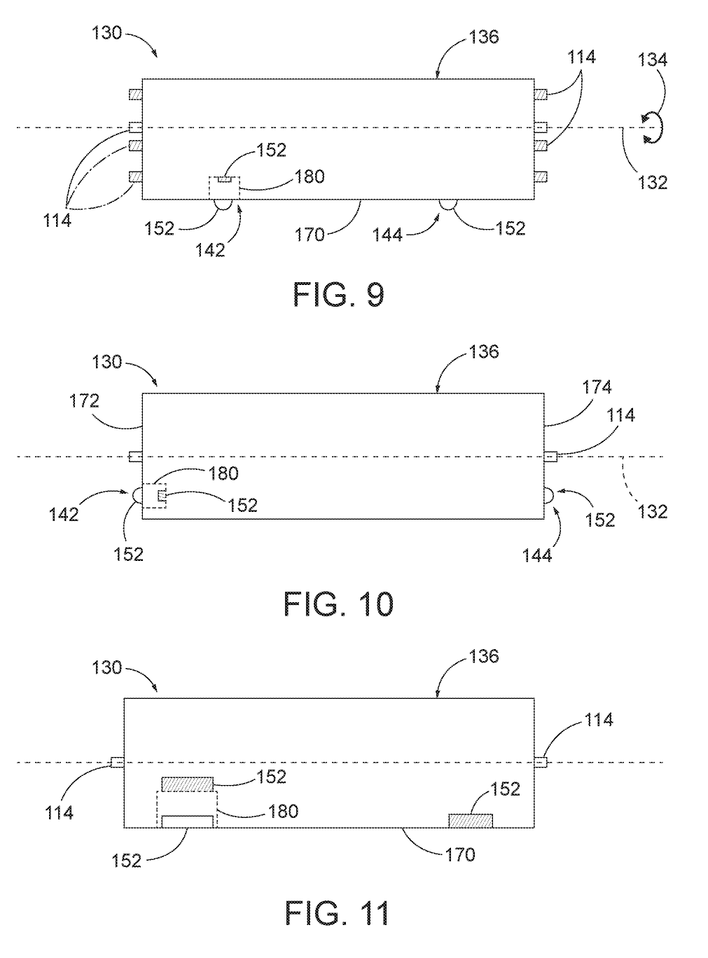

FIGS. 1-22 provide examples of adjustable shutters 100 according to the present disclosure. Elements that serve a similar, or at least substantially similar, purpose are labeled with like numbers in each of FIGS. 1-22, and these elements may not be discussed in detail herein with reference to each of FIGS. 1-22. Similarly, all elements may not be labeled in each of FIGS. 1-22, but reference numbers associated therewith may be utilized herein for consistency. Elements, components, and/or features that are discussed herein with reference to one or more of FIGS. 1-22 may be included in and/or utilized with any of FIGS. 1-22 without departing from the scope of the present disclosure.

In general, elements that are likely to be in a given (i.e., a particular) embodiment are illustrated in solid lines, while elements that are optional to a given embodiment or relate to an alternative embodiment are illustrated in dashed lines. However, elements that are shown in solid lines are not essential to all embodiments, and an element shown in solid lines may be omitted from a given embodiment without departing from the scope of the present disclosure,

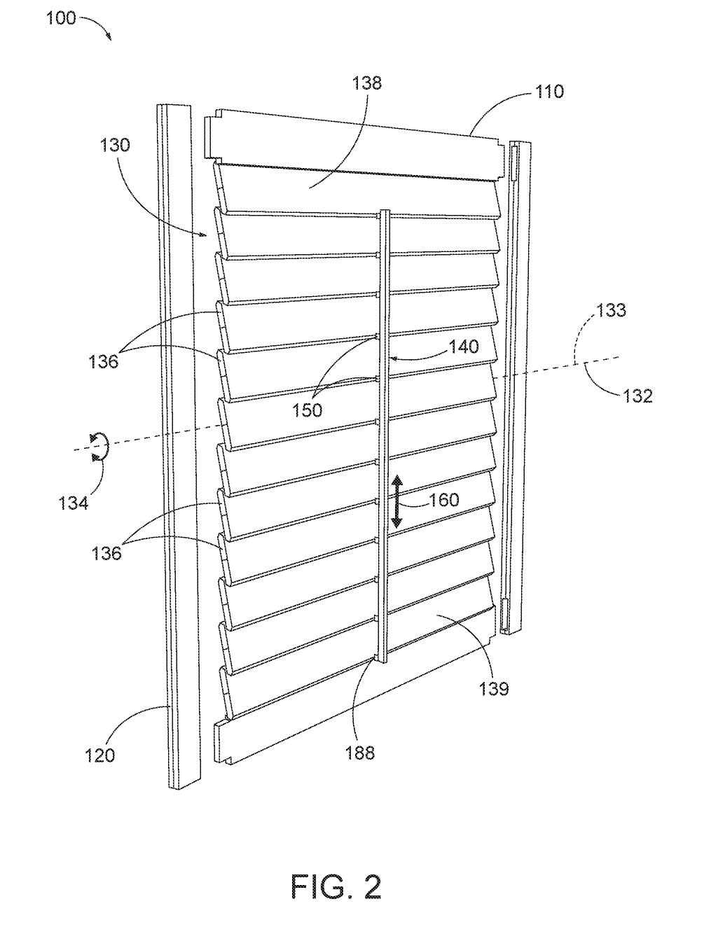

As illustrated in FIGS. 1-2, an adjustable shutter 100 according to the present disclosure includes a frame 110 that is configured to be installed in an aperture 120, such as a window, doorway, cutout, vent, etc. For example, adjustable shutter 100 may be configured to be attached to a window frame of a window. Frame 110 defines a shutter plane 112 of adjustable shutter 100. As used herein, adjustable shutter 100 also may be referred to as a shutter 100, a window shutter 100, and/or an adjustable window shutter 100.

Shutter 100 and/or frame 110 may have any appropriate shape, such as to correspond to the shape and/or size of the opening and/or frame to which the shutter will be installed. For example, and as illustrated in FIGS. 1-2, frame 110 may have a shape that is rectangular. However, this is not required to all shutters, and it is additionally within the scope of the present disclosure that shutter 100 and/or frame 110 may have a shape that is elliptical, oval, circular, quarter-circular, partial circular, triangular, rectangular, wedge-shaped, a polygon, and/or any appropriate combination thereof.

As indicated in FIGS. 1-2, shutter 100 includes a first face 102 and a second face 104 opposite the first face, such that each of the first face and the second face are generally parallel to shutter plane 112. In an embodiment in which shutter 100 is installed adjacent a window, shutter 100 may be oriented such that second face 104 generally faces toward the window and first face 102 generally faces away from the window. However, this configuration is not required to all embodiments, and it is within the scope of the present disclosure that first face 102 and second face 104 have any appropriate spatial relationship with a structure upon which or within which shutter 100 is installed. As used herein, first face 102 and/or second face 104 may refer to respective faces and/or sides of any appropriate component and/or portion of shutter 100. According to the present disclosure, frame 110 may have any appropriate construction.

Shutter 100 further includes a plurality of louvers 130 that each are coupled for pivotal movement relative to frame 110, such as about a pivot axis 132 of the corresponding louvers. As used herein, louver 130 also may be referred to as a slat 130. As illustrated in FIGS. 1, 3, and 11-16, each of the plurality of louvers 130 may be connected to frame 110 via one or more pivot joints 114 such as pins, axles, etc. As illustrated in FIG. 1, pivot joints 114 of louver 130 may extend into opposed sidewalk 116 of the shutter's frame 110 to enable pivotal movement 134 of louver 130 relative to frame 110. Pivot joints 114 may be integrally formed with louver 130 or may be separately formed and subsequently attached to the louvers. Pivot axes 132 of each of the plurality of louvers 130 may extend parallel o each other and/or may all pivot about parallel pivot axes 132.

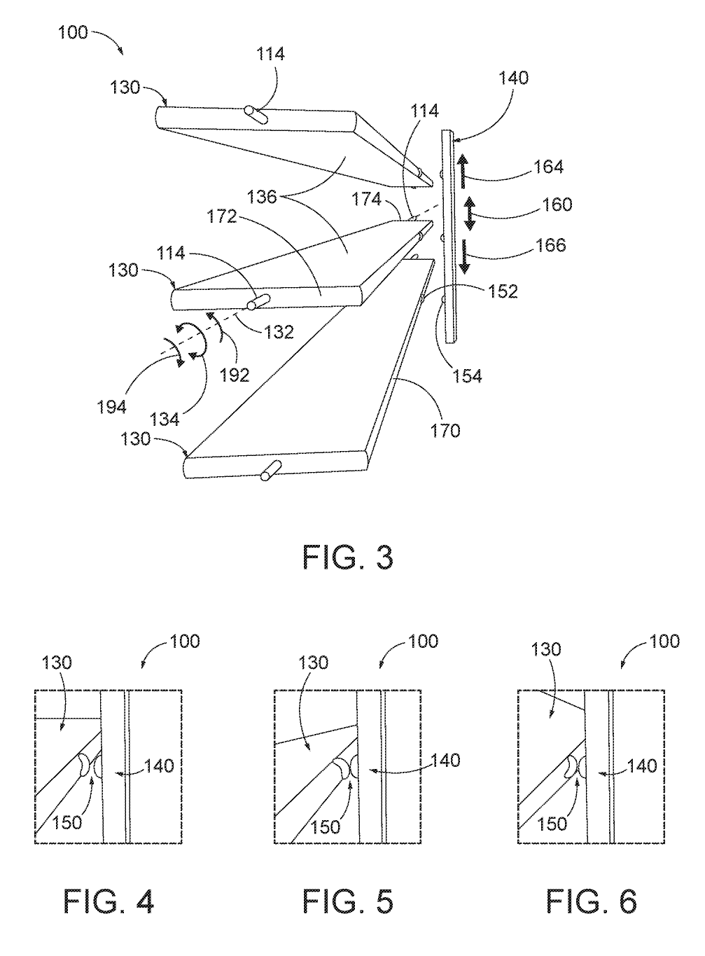

FIGS. 1 and 3 illustrate pivot joints 114 being centrally positioned in relation to a first side edge region 172 and/or in relation to a central, or longitudinal, axis 133 of a corresponding louver 136. As used herein, corresponding louver 136 refers to a louver 130 of the plurality of louvers that is coupled to, associated with, connected to, etc. the other components or elements being described therewith. As an example, in the current example, corresponding louver 136 is a louver 130 that is illustrated in FIGS. 1 and 3 and described in connection with pivot joints 114. In such an embodiment, pivot axis 132 may be described as being collinear with central axis 133 of louver 130, and equal, or at least substantially equal, portions of louver 130 will extend from each side of the louver's plane.

Collinear pivot axes 132 and central axes 133 are not required to all louvers 130 according to the present disclosure and other relative orientations of the pivot axes and central axes are within the scope of the present disclosure, including pivot joints 114 and/or pivot axes 132 that are non-collinear with central axis 133 of louver 130. This is schematically illustrated in dash-dot lines in FIGS. 1 and 11, in which pivot joints 114 and/or pivot axis 132 are spaced apart from central axis 133 of corresponding louver 136. A non-collinear orientation between pivot axis 132 and central axis 133 of louver 130 may permit a greater amount of each louver to pivot into or out of one side of the louver's plane than the other side of the louver's plane. All louvers of a particular shutter typically will have pivot axes that are similarly, or even identically, oriented relative to the longitudinal axes of the plurality of louvers, but this is not required to all shutters according to the present disclosure.

Shutter 100 is configured to selectively transition between an open orientation (as illustrated in FIG. 1) and at least one closed orientation (such as illustrated in FIG. 2) by pivoting each louver 130 with respect to shutter plane 112, such as about the pivot axis 132 of each of louver 130. An amount of light incident on shutter 100 is obscured by the plurality of louvers 130, where the amount of light obscured is relationally dependent upon the angular position of the plurality of louvers 130 about their corresponding pivot axes 132. Pivot axis 132 may be at least substantially parallel to a longitudinal axis of corresponding louver 136. Many shutters may define two closed orientations, such as when the louvers have been pivoted from a fully open configuration, such as is shown in FIG. 1, in a clockwise or counterclockwise direction to define respective closed positions. The radial distance between the fully closed positions may be referred to as the pivotal range, range of pivotal positions, or pivotal range of movement of the plurality of louvers 130.

Shutter 100 further includes a louver adjustment rod 140 that interconnects the plurality of louvers 130 such that translational movement of louver adjustment rod 140 causes simultaneous pivoting of the plurality of louvers 130 about their respective pivot axis 132.

According to the present disclosure, louver adjustment rod 140 is magnetically interconnected with the plurality of louvers 130 via a plurality of magnetic couplings 150. Louver adjustment rod 140 additionally or alternatively may be described as magnetically coupling with, being magnetically coupled to, and/or interconnecting with the plurality of louvers 130. Individual magnetic couplings 150 between louver adjustment rod 140 and louver 130 of the plurality of louvers 130 comprise a louver magnetic coupling element 152, which is included in and/or on corresponding louver 136, and a rod magnetic coupling element 154, which is included in and/or on louver adjustment rod 140.

Louver magnetic coupling element 152 and rod magnetic coupling element 154 may include and/or be any appropriate materials suitable to generate an attractive magnetic force therebetween. As an example, one of louver magnetic coupling element 152 and rod magnetic coupling element 154 may include and/or be at least partially formed from a permanent magnetic material 151 (i.e., a material that is magnetized and creates its own persistent magnetic field), and the other of the louver magnetic coupling element 152 and rod magnetic coupling element 154 may include and/or he at least partially formed from a permanent magnetic material 151 and/or a ferromagnetic material 153. This is illustrated schematically in FIG. 1 and applies to all of the louver magnetic coupling elements 152 and rod magnetic coupling elements 154 disclosed and/or illustrated herein.

As further illustrated in FIG. 3, louver adjustment rod 140 is configured to receive an imparted translational adjustment 160 (e.g., upward movement, downward movement, etc.). Responsive to receipt of imparted translational adjustment 160, and via the plurality of magnetic couplings 150, louver adjustment rod 140 causes each of the plurality of louvers 130 to move pivotally (e.g., clockwise, counterclockwise, etc.) about their respective pivot axes 132. Imparted translational adjustment 160 may be imparted along a translational pivot axis that is perpendicular to the pivot axes of the individual louvers 130. For example, the translational pivot axis may be a vertical axis when pivot axis 132 is horizontal. Alternatively, the translational pivot axis may be a horizontal axis when pivot axis 132 is vertical.

According to the present disclosure, each magnetic coupling 150 is configured to cause corresponding louver 136 to move pivotally about its pivot axis 132 in a first pivot direction 192 (e.g., counter clockwise) in correspondence with imparted translational adjustment 160 to louver adjustment rod 140 in a first translational direction (e.g., upward, left to right, etc.). For example, FIG. 3 illustrates that the magnetic interconnection causes louvers 130 to pivot in first pivot direction 192 (i.e., counter clockwise) in correspondence with a translation of louver adjustment rod 140 in a first translational direction 164 (i.e., upwards). FIG. 5 is an example illustration that shows louver magnetic coupling 150 after the translation of louver adjustment rod 140 causes the plurality of louvers 130 to pivot in first pivot direction 192.

Each magnetic coupling 150 also may cause corresponding louver 136 to move pivotally about its pivot axis 132 in a second pivot direction 194 (e.g., clockwise) correspondence with imparted translational adjustment 160 to louver adjustment rod 140 (e.g., downward, right to left, etc.). In this way, the plurality of magnetic couplings 150 between louver adjustment rod 140 and the plurality of louvers 130 may cause each of the plurality of louvers 130 to synchronously pivot in correspondence with a single imparted translational adjustment 160 to louver adjustment rod 140. For example, FIG. 3 illustrates that the magnetic interconnection causes louvers 130 to pivot in second pivot direction 194 (i.e., clockwise) in correspondence with a translation of the louver adjustment rod 140 in a second translational direction 166 (i.e., downwards). FIG. 6 is an example illustration that shows magnetic coupling 150 after the translation of louver adjustment rod 140 causes the plurality of louvers 130 to pivot in second pivot direction 166.

Moreover, each magnetic coupling 150 is configured to maintain magnetic connection across a full range of pivotal movement of louvers 130. The full range of pivotal movement of louvers 130 is indicated schematically at 134 and may extend from a first closed orientation in which louvers 130 are fully closed in a first rotational direction (such as the louver orientation illustrated in FIG. 2) to a second closed orientation which louvers 130 are fully closed in a second rotational direction that is opposite the first rotational direction. The full range of pivotal movement 134 of louvers 130 also includes louver orientations in between these two closed orientations, such as the example louver orientations shown in FIGS. 1 and 4-6.

As illustrated in FIGS. 3-8, one or more of louver magnetic coupling element 152 and rod magnetic coupling element 154 may be arcuate, rounded, hemispherical, or otherwise shaped so that a strong magnetic connection is maintained between louver magnetic coupling element 152 and rod magnetic coupling element 154 across the full range of pivotal movement 134 of louvers 130. That is, one or more of louver magnetic coupling element 152 and rod magnetic coupling element 154 may be shaped such that they maintain a rolling magnetic connection as louvers 130 pivot to different positions. Additionally, in some embodiments of the present disclosure, louver magnetic coupling element 152 may project outward from a surface of corresponding louver 136 and/or a recess 180, and/or rod magnetic coupling element 154 may project outward from the surface of louver adjustment rod 140 such that the magnetic interconnection between louver magnetic coupling element 152 and rod magnetic coupling element 154 is maintained across the full range of pivotal movement 134 of louvers 130. Alternatively or in addition, the interior wall of recess 180 may be curved, angled, or otherwise shaped to preserve the connection between louver magnetic coupling element 152 and rod magnetic adjustment element 154 as louver adjustment rod 140 is translated.

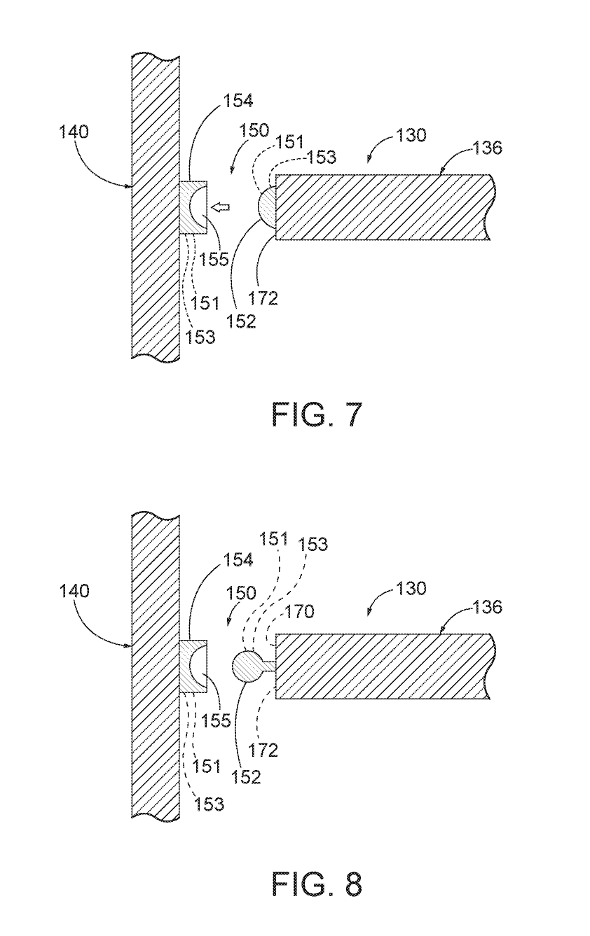

As illustrated in FIGS. 7-8, one of louver magnetic coupling element 152 and rod magnetic coupling element 154 may be a socket element having a concave receiving surface 155, and the other of louver magnetic coupling element 152 and rod magnetic coupling element 154 may have a convex shape (as illustrated in FIG. 7) and/or a ball shape (as illustrated in FIG. 8) that is configured to maintain a rolling magnetic connection with concave receiving surface 155 as louvers 130 pivot to different positions within the full range of pivotal movement. For example, the convex shape of the other of louver magnetic coupling element 152 and rod magnetic coupling element 154, as illustrated in FIG. 7, enables magnetic coupling 150 located on first side edge region 172 of corresponding louver 136 to maintain a rolling magnetic connection as louvers 130 are pivoted. In the embodiment illustrated in FIG. 8, magnetic coupling 150 may be located on either front edge regions 170 or first side edge regions 172 of corresponding louver 136, since the ball shape of the other of the louver magnetic coupling element 152 and rod magnetic coupling element 154 enables the magnetic coupling 150 to maintain magnetic contact when louvers 130 are pivoted through their full range of pivotal movement relative to the frame of the shutter. In each of FIG. 7-8, louver magnetic coupling element 152 is depicted as having a convex and/or ball shape and rod magnetic coupling element 154 is depicted as being a socket element, however it is within the scope of the disclosure that in various embodiments louver magnetic coupling element 152 may be a socket element and rod magnetic coupling element 154 may have a convex and/or ball shape.

A benefit of shutters 100 disclosed herein is that a disconnect of magnetic coupling 150 is not permanent, since the magnetic linkage may he reestablished once louver magnetic coupling element 152 and corresponding rod magnetic coupling element 154 return into contact with each other and/or into sufficiently close proximity to reestablish the magnetic coupling. That is, when magnetic coupling 150 is uncoupled, such as when a force (e.g., a frictional force, a blunt force, a translational force, etc.) incident to shutter 100 and/or individual component(s) of shutter 100 causes separation between louver magnetic coupling element 152 and corresponding rod magnetic coupling element 154, the magnetic connection may be reestablished subsequently without tools, and without damage to shutter 100. For example, once magnetic coupling 150 for corresponding louver 136 is uncoupled, corresponding louver 136 no longer pivots in concert with imparted translational force 160 on louver adjustment rod 140. When this occurs, corresponding louver 136 may remain in its pivot position from when the separation occurred, may pivot away from the other louvers due to gravity and/or another imparted force, etc. As such, the louver adjustment rod no longer stabilizes or dictates the pivotal position of the louver relative to the remainder of the plurality of louvers. This uncoupling may be remedied (i.e., magnetic coupling 150 between corresponding louver 136 and louver adjustment rod 140 is reestablished) when louver magnetic coupling element 152 of corresponding louver 136 becomes proximate to corresponding rod magnetic coupling element 154, which occurs when (i) louver adjustment rod 140 is translated such that the plurality of louvers 130 have substantially the same pivot position to corresponding louver 136, (ii) corresponding louver 136 is manually adjusted to have the same pivot position as the plurality of louvers 130, or a combination thereof.

According to the present disclosure, each of the plurality of louvers 130 has a front edge region 170 that extends along louvers 130 in parallel with shutter plane 112 of shutter 100. Front edge region 170 corresponds to first face 102 of the plurality of louvers 130. Each of the plurality of louvers 130 may also include at least one of first side edge region 172 that may extend perpendicularly from front edge region 170, and a second side edge region 174 that may extend perpendicularly from front edge region 170 and is opposite to first side edge region 172.

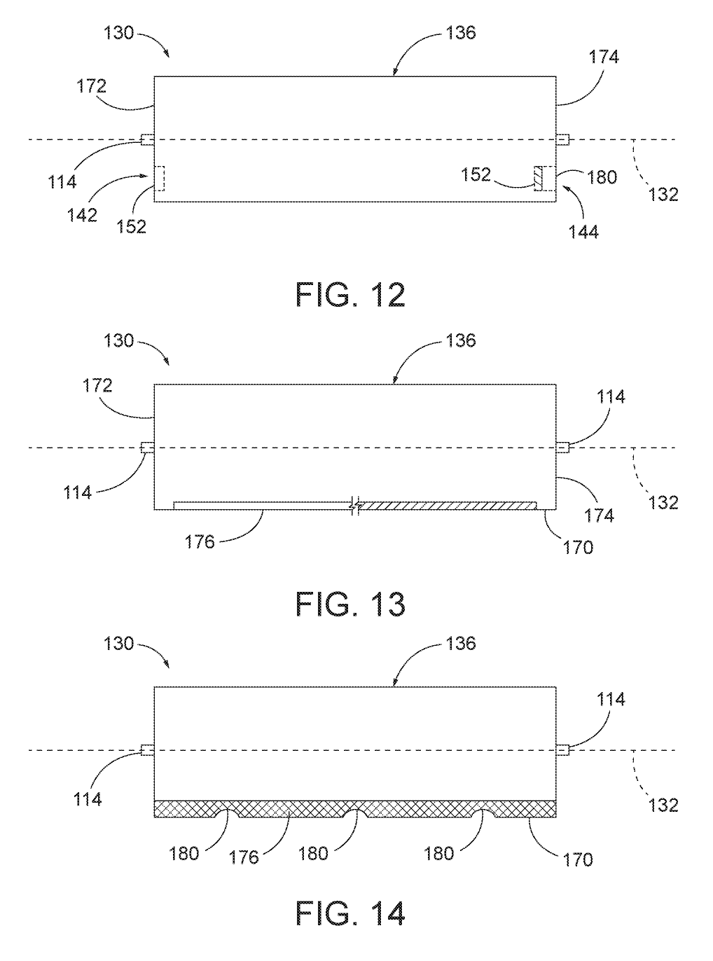

In some embodiments, the plurality of louvers 130 each may include a single louver magnetic coupling element 152. In such embodiments, louver magnetic coupling elements 152 may be positioned in relation to each of the plurality of louvers 130 such that they each may be concurrently in magnetic connection with corresponding rod magnetic coupling element 154 of louver adjustment rod 140. Alternatively, louvers 130 each may include a plurality of louver magnetic coupling elements 152, with individual louver magnetic coupling elements 152 corresponding to a potential coupling position of louver adjustment rod 140 to louver 130. For example, and as illustrated schematically in FIGS. 1 and 11, a first set of the louver magnetic coupling elements 156 may be positioned such that they each may be concurrently in magnetic connection with a corresponding rod magnetic coupling element 154 of louver adjustment rod 140 when louver adjustment rod 140 is in a first potential rod attachment position 142. Moreover, a second set of louver magnetic coupling elements 158 may be positioned such that they each may be concurrently in magnetic connection with corresponding rod magnetic coupling element 154 of louver adjustment rod 140 when louver adjustment rod 140 is in a second potential rod attachment position 144 that is spaced apart from first potential rod attachment position 142. In FIG. 11, first and second potential rod attachment positions 142 and 144 are spaced apart on front edge region 1.70 of louver 130. Additional examples include first and second potential rod attachment positions 142 and 144 respectively being on first and second side edge regions 172 and 174 of louver 130 (such as shown in FIGS. 12 and 14), and/or first potential rod attachment position 142 on front edge region 170 and second potential rod attachment position 144 on a side edge region (or both side edge regions) of louver 130 (such as shown in FIG. 1). In this way, embodiments with two or more such sets of louver magnetic coupling elements 152 may allow a user to adjust a positioning of louver adjustment rod 140 between multiple corresponding potential attachment positions to align with personal preference, to avoid obscuring an object/field of vision, or for other reasons.

As schematically illustrated in FIGS. 11-16, the present disclosure covers many arrangements and types of louvers 130, louver magnetic coupling elements 152, recesses 180, and combinations thereof. However, the potential combinations covered by the present disclosure are not limited to those depicted in FIGS. 11-16. Likewise, the examples of FIGS. 11-16 may be utilized in any of shutters 100 described and/or illustrated herein.

For example, and as illustrated in FIG. 11, individual louver magnetic coupling elements 152 may be included in front edge region 170 of corresponding louver 136. According to the present disclosure, louver 130 may contain one or many louver magnetic coupling elements 152, which may be individually positioned proximate to recess 180, as shown in FIG. 11. Alternatively or in addition, individual louver magnetic coupling elements 152 may be included in one or more of first side edge region 172 and second side edge region 174, as shown in FIG. 12. Where louver magnetic coupling elements 152 are included in one of first or second side edge regions 172 or 174 of the plurality of louvers 130, and when louver adjustment rod 140 is magnetically interconnected with the plurality of louvers 130, louver adjustment rod 140 may be located in first or second potential rod attachment position 142 or 144 proximate to corresponding first or second side edge region 172 or 174 of the plurality of louvers 130.

In some embodiments, some or all of louver magnetic coupling elements 152 may be attached to a location on the surface of front edge region 170, first side edge region 172, and/or second side edge region 174 of corresponding louvers 136. For example, louver magnetic element 152 may be attached by any suitable manner, such as by being adhered, fastened, frictionally retained, and/or mechanically secured against and/or within corresponding louver 136.

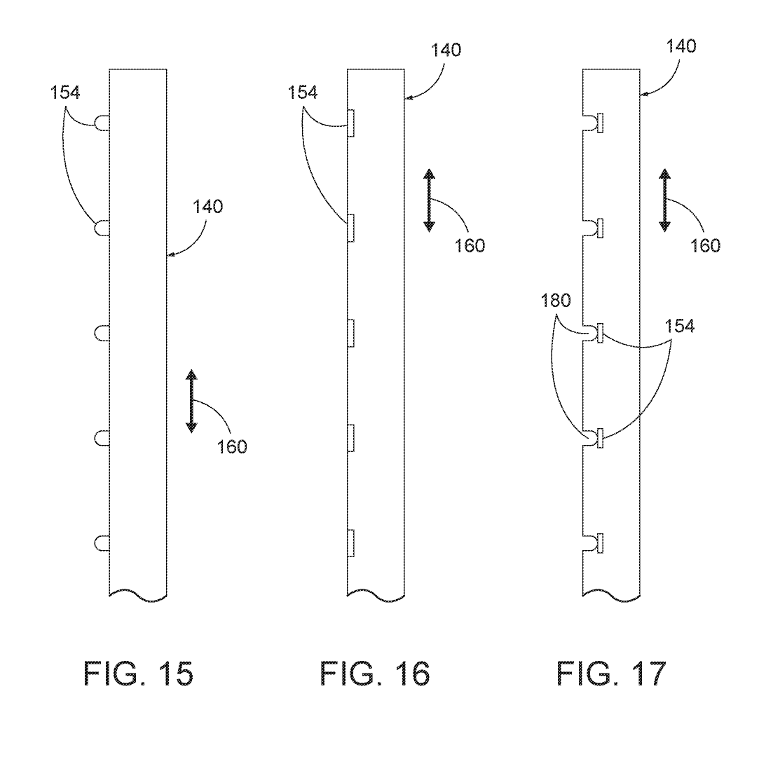

Alternatively or in addition, some or all of louver magnetic coupling elements 152 may be embedded within front edge region 170, first side edge region 172, and/or second side edge region 174 of corresponding louvers 136. For example, and as illustrated in FIG. 13 and 15, individual louver magnetic coupling elements 152 may be embedded within a portion of corresponding louver 136 such that louver magnetic coupling element 152 is able to magnetically couple to corresponding rod magnetic coupling element 154 while also being partially or entirely concealed.

In some embodiments, some or all of louver magnetic coupling elements 152 may correspond to elongated magnetic elements 176 that extend along a length of one of front edge region 170, first side edge region. 172, and/or second side edge region 174 of corresponding louver 136. For example, as illustrated in FIG. 15, elongated magnetic element 176 may correspond to a magnetic material that is attached to (as shown on the left side of elongated magnetic element 176 in FIG. 15) and/or embedded within one or more of front edge region 170 (as shown on the right side of elongated magnetic element 176 in FIG. 15), first side edge region 172, and/or second side edge region 174 of corresponding louver 136.

In such an embodiment, corresponding rod magnetic coupling elements 154 may be configured to slide along corresponding elongated magnetic element 176 while remaining magnetically coupled to elongated magnetic element 176. Thus, in an embodiment that includes elongated magnetic elements 176, a user is able to adjust a positioning of the louver adjustment rod 140 in relation to the frame 110 by applying a horizontal translational force to the louver adjustment rod 140. Such a horizontal translational force is illustrated schematically by the double headed horizontal arrow in FIG. 1. In this way, elongated magnetic element 176 may allow a user to adjust a positioning of louver adjustment rod 140 in relation to frame 110 to align with personal preference, to avoid obscuring an object/field of vision, or for other reasons. As shown in FIG. 16, elongated magnetic coupling element 176 of the present disclosure may include one or more recesses 180 configured to accept a portion of louver adjustment rod 140. In some embodiments, individual recesses may correspond to potential rod attachment positions of the louver adjustment rod.

Individual louvers 130 of the plurality of louvers 130 also may include one or more recesses 180 that receive at least a portion of louver adjustment rod 140. In such embodiments, louver magnetic coupling element 152 may be located proximate to recess 180 such that louver magnetic coupling element 152 magnetically couples to corresponding rod magnetic coupling element 154 when louver adjustment rod 140 is within recess 180. In this way, by having at least a portion of louver adjustment rod 140 located within recess 180, the profile of louver adjustment rod 140 may be reduced while preserving its magnetic interconnection with the plurality of louvers 130. The walls of recess 180 also may improve stability of louver adjustment rod 140 by limiting the potential range of movement that louver adjustment rod 140 may be translated.

As schematically illustrated in FIGS. 17-22, the present disclosure covers many arrangements and types of louver adjustment rods 140, rod magnetic coupling elements 154, recesses 180, and combinations thereof. However, the potential combinations covered by the present disclosure are not limited to those depicted in FIGS. 17-22. Likewise, the examples of FIGS. 17-22 may be utilized in any of shutters 100 described and/or illustrated herein.

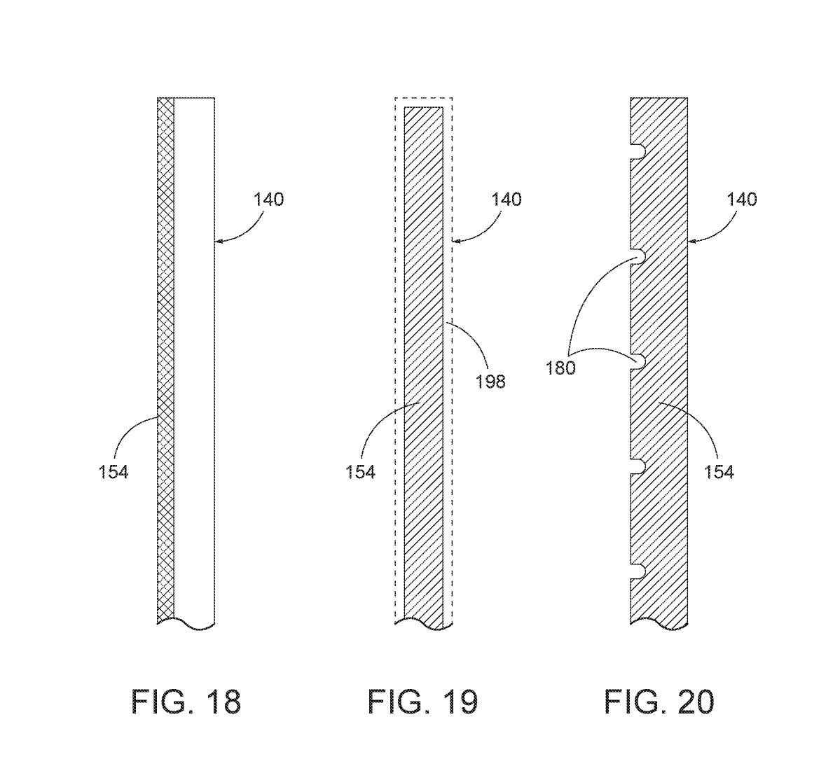

In some embodiments, rod magnetic coupling element 154 may be attached to a location on a surface of louver adjustment rod 140, such as shown in FIG. 17, and/or embedded within louver adjustment rod 140, such as shown in FIG. 18. For example, individual rod magnetic coupling elements 154 may be attached to a surface of louver adjustment rod 140 by any suitable manner, such as by being adhered, fastened, and/or mechanically secured against and/or within louver adjustment rod 140. Alternatively or in addition, and as illustrated in FIGS. 18-19, individual rod magnetic coupling elements 154 may be partially or completely embedded within a portion of louver adjustment rod 140, such that rod magnetic coupling element 154 may magnetically couple to corresponding louver magnetic coupling element 152 while remaining partially or entirely covered.

In embodiments where louver adjustment rod 140 includes more than one rod magnetic coupling element 154, namely, a plurality of rod magnetic coupling elements 154, rod magnetic coupling elements 154 may be spaced apart from each other along louver adjustment rod 140. For example, and as illustrated in FIGS. 1-3 and 17-19, the plurality of rod magnetic coupling elements 154 may be spaced apart such that, when coupled to corresponding louver magnetic coupling elements 152, the louvers concurrently are oriented in an at least substantially the same pivot position and/or pivot angle.

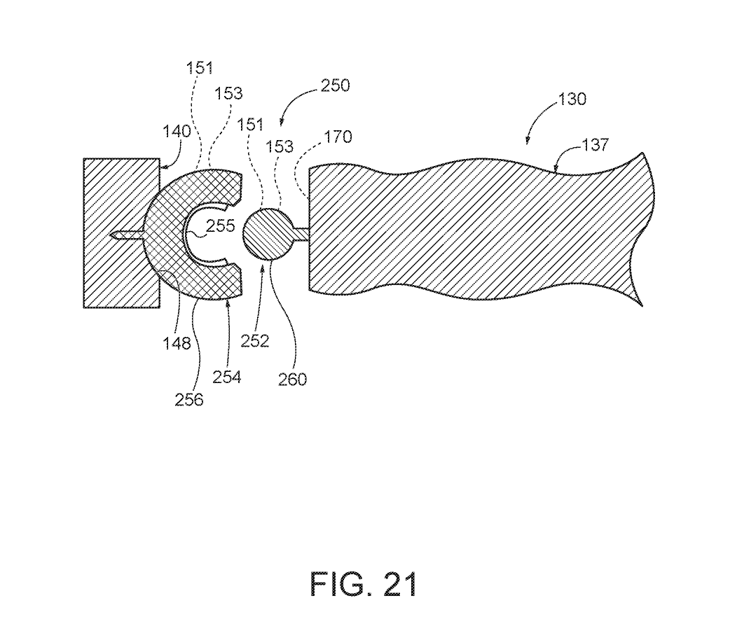

Individual rod magnetic coupling elements 154 may be configured to magnetically couple to a single louver magnetic coupling element 152, as illustrated in FIGS. 1-6 and 17-19, or to magnetically couple to a plurality of louver magnetic coupling elements 152 concurrently, as illustrated in FIGS. 20-22. For example, FIG. 20 shows louver adjustment rod 140 that includes a single rod magnetic coupling element 154 that concurrently couples to each corresponding louver magnetic coupling element 152 of the plurality of louvers 130. Alternatively or in addition, louver adjustment rod 140 may itself comprise a magnetic material (i.e., a magnet, iron, nickel, cobalt, etc.). For example, as shown in FIG. 20, louver adjustment rod 140 may comprise a magnetic or ferromagnetic rod which optionally may be encased in a coating or cover 198.

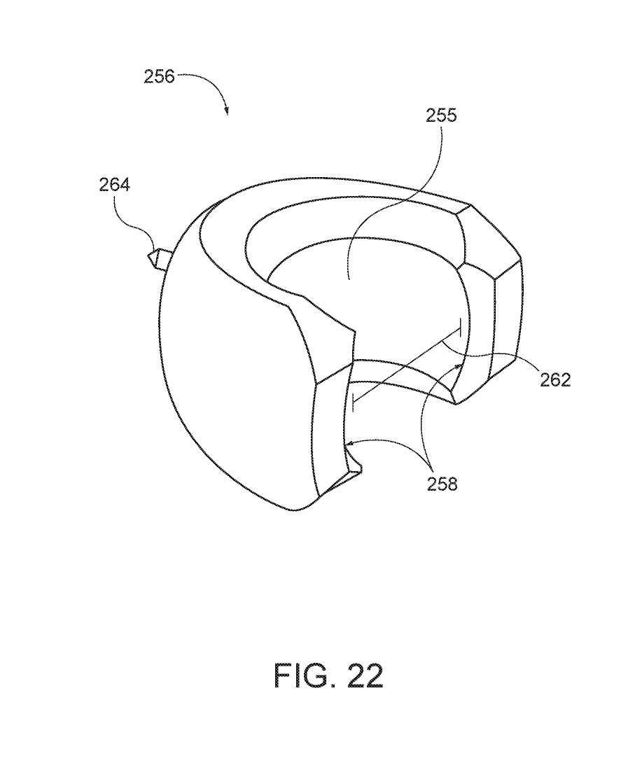

Additionally, as illustrated in FIGS. 19 and 22, louver adjustment rod 140 also may include one or more recesses 180 configured to accept at least a portion of corresponding louver 136. In such embodiments, rod magnetic coupling element 154 may be located proximate to recesses 180 such that, when at least a portion of corresponding louver 136 is positioned in recess 180, the rod magnetic coupling element 154 magnetically couples to louver magnetic coupling element 152 of corresponding louver 136, such as shown in FIG. 19.

According to the present disclosure, shutter 100 optionally may include a support louver 137 that is mechanically coupled to louver adjustment rod 140. The schematic illustration of FIG. 1 shows shutter 100 as having a first support louver 138 as being the topmost louver 130 and a second support louver 139 as being the bottommost louver 130. However, in different embodiments, shutter 100 may have more or fewer support louvers 137. For example, shutter 100 may have no support louvers 137, meaning that louver adjustment rod 140 may be selectively removed from and recoupled to shutter 100 without causing any permanent damage to shutter 100 and/or without requiring any tools. Support louver 137 may be coupled to louver adjustment rod 140 via any suitable manner, such as by being adhered, fastened, frictionally retained, and/or mechanically secured against and/or within louver adjustment rod 140. For example, louver adjustment rod 140 may be attached to support louver 137 using a mechanical attachment mechanism 188, such as staples, pins, interlocking pivotal components, etc. Mechanical attachment mechanism 188 additionally or alternatively may be referred to as a mechanical coupling mechanism 188. In some embodiments, the mechanical attachment mechanism 188 also may include and/or be at least partially formed from a permanent magnetic material 151, and/or a ferromagnetic material 153. In such an embodiment, the mechanical attachment mechanism additionally or alternatively may be described as a magnetic coupling element. Support louver 137 optionally may include louver magnetic coupling element 152 that magnetically couples to rod magnetic coupling element 154 of louver adjustment rod 140, in which case support louver 137 also may be one of the plurality of louvers 130 that each include louver magnetic coupling element 152. In some embodiments, each of the plurality of louvers 130 may be a support louver 137.

As illustrated in FIG. 21, support louver 137 may he connected to louver adjustment rod 140 by a mechanical coupling 250. Mechanical coupling 250 may include a mechanical louver coupling element 252 and a mechanical rod coupling element 254. As shown in FIG. 21, the mechanical rod coupling element 254 may be a socket element 256 having a concave receiving surface 255, and the louver mechanical coupling element 252 may be a ball element 260 having a convex shape and/or a ball shape (as illustrated in FIG. 21). Alternatively, or additionally, the mechanical rod coupling element 254 may be a ball element 260, and the louver mechanical coupling element 252 may be a socket element 256 having a concave receiving surface 255. The ball element 260 may be configured to maintain a rolling mechanical connection with concave receiving surface 255 as louvers 130 pivot relative to frame 110 and louver adjustment rod 140 to different positions within the full range of pivotal movement. In some embodiments, one of mechanical louver coupling element 252 and mechanical rod coupling element 254 may include and/or be at least partially formed from a permanent magnetic material 151, and the other of the mechanical louver coupling element 252 and mechanical rod coupling element 254 may include and/or be at least partially formed from a permanent magnetic material 151 and/or a ferromagnetic material 153. In such an embodiment, the support louver 137 would be both mechanically and magnetically coupled with the louver adjustment rod 140. In the embodiment illustrated in FIG. 21, mechanical coupling 250 is schematically illustrated as being located on front edge region 170 of the louver. It is within the scope of the present disclosure that the mechanical coupling may be located on a side edge region 172 of the support louver 137.

Mechanical louver coupling element 252 and mechanical rod coupling element 254 may be attached to the support louver 137 and louver adjustment rod 140, respectively, via any suitable manner, such as by being adhered, fastened, frictionally retained, and/or mechanically secured against and/or within support louver 137 or louver adjustment rod 140. FIG. 21 illustrates the louver adjustment rod 140 as including a recessed groove 148 that accepts the mechanical rod coupling element 254. However, in other embodiments the mechanical rod coupling element 254 may be mounted on a flat surface of the louver adjustment rod. For example, in such an embodiment the mechanical rod coupling element 254 may have a flat attachment surface that is configured to sit flush against the surface of the louver adjustment rod 140 when the mechanical rod coupling element 254 is attached and/or affixed to the louver adjustment rod 140.

As illustrated in FIG. 22, the socket element 256 also may include at least one retaining surface 258 that is configured to maintain the mechanical connection between the socket element and the ball element 260. The retaining surface 258 may allow the ball element 260 to be selectively removed from and recoupled to the socket element 256 without causing damage to the mechanical coupling element 250 and/or without requiring any tools. For example, the socket element 256 may include a mechanical opening 262 through which the ball element 260 may be inserted to mechanically connect the ball element 260 to the socket element 256, and/or through which the ball element 260 may be removed to disengage the mechanical connection between the ball element 260 and the socket element 256. Specifically, at least a portion of the socket element 256 and/or ball element 260 may be configured to resiliently deflect or deform to permit the selective insertion and removal of the ball element into and out of the socket element without damage to the ball element or the socket element. For example, the ball element may be inserted into the socket element in a snap-fit manner. The socket element 256 may also include an attachment pin 264 by which the socket element 256 may be mechanically attached to one of a louver 136 and the louver adjustment rod 140.

Additional examples of suitable structures for mechanical couplings 250, including mechanical louver coupling elements 252 and mechanical rod coupling elements 254, are disclosed in U.S. Patent Application Nos. 2004/0025438 and 2009/0126277, and in U.S. Pat. Nos. 6,854,211, 5,187,896, 5,548,925, and 456,306, the complete disclosures of which are disclosed herein by reference.

Additional examples of shutters 100 according to the present disclosure are described in the following enumerated paragraphs:

A1. An adjustable shutter, comprising: a frame; a plurality of louvers coupled for pivotal rotation relative to the frame, wherein each louver of the plurality of louvers is: configured to be pivoted about a pivot axis of a corresponding louver, and comprises a louver magnetic coupling element; a louver adjustment rod including at least one rod magnetic coupling element magnetically coupled to the louver magnetic coupling elements of the plurality of louvers; and wherein the louver adjustment rod is configured to receive an imparted translational adjustment and wherein responsive to receipt of the imparted translational adjustment, the louver adjustment rod causes each of the plurality of louvers to pivot about the respective pivot axis of the corresponding louver.

A2. The adjustable shutter of paragraph A1, wherein each louver magnetic coupling elements configured to cause the corresponding louver to: pivot about the pivot axis of the corresponding louver in a first pivot direction in correspondence with a first imparted translational adjustment to the louver adjustment rod in a first translational direction, and pivot about the pivot axis of the corresponding louver in a second pivot direction in correspondence with a second imparted translational adjustment to the louver adjustment rod in a second translational direction, wherein the first pivot direction opposes the second pivot direction.

A3. The adjustable shutter of paragraph A1 or A2, wherein each of the plurality of louvers includes a front edge region, and wherein each louver magnetic coupling element is included in the front edge region of the corresponding louver.

A4. The adjustable shutter of paragraph A1 or A2, wherein each louver of the plurality of louvers includes a first side edge region and a second side edge region opposite the first side edge region, and wherein each louver magnetic coupling element is included in one of the first side edge region and the second side edge region of the corresponding louver.

A4.1. The adjustable shutter of paragraphs A1-A4, wherein each of the at least one rod magnetic coupling elements is a socket element having a concave receiving surface, and each louver magnetic coupling element has a convex shape configured to maintain a rolling magnetic connection with the concave receiving surface of a corresponding rod magnetic coupling element. A4.2. The adjustable shutter of paragraphs A1-A4, wherein each louver magnetic coupling element is a socket element having a concave receiving surface, and each of the at least one rod magnetic coupling elements has a convex shape configured to maintain a rolling magnetic connection with the concave receiving surface of a corresponding louver magnetic coupling element.

A4.3. The adjustable shutter of paragraphs A1-A4, wherein each of the at least one rod magnetic coupling elements is a socket element having a concave receiving surface, and each louver magnetic coupling element has a ball shape configured to maintain a rolling magnetic connection with the concave receiving surface of a corresponding rod magnetic coupling element.

A4.4. The adjustable shutter of paragraphs A1-A4, wherein each louver magnetic coupling elements a socket element having a concave receiving surface, and each of the at least one rod magnetic coupling elements has a ball shape configured to maintain a rolling magnetic connection with the concave receiving surface of a corresponding louver magnetic coupling element.

A5. The adjustable shutter of any of paragraphs A1-A4, wherein each louver of the plurality of louvers includes at least: a first louver magnetic coupling element associated with a first position of the louver adjustment rod relative to the corresponding louver; and a second louver magnetic coupling element associated with a second position of the louver adjustment rod relative to the corresponding louver; and further wherein the louver adjustment rod is configured to be selectively magnetically coupled to the first louver magnetic coupling elements of the plurality of louvers or the second louver magnetic coupling elements of the plurality of louvers.

A6. The adjustable shutter of any of paragraphs A3-A5, wherein each louver magnetic coupling element corresponds to a magnetic element attached to a location on the surface of one of the front edge region, the first side edge region, or the second side edge region of the corresponding louver.

A6.1. The adjustable shutter of any of paragraphs A3-A6, wherein the first louver magnetic coupling element is attached to the first side edge region, and the second louver magnetic coupling element s attached to the front edge region.

A6.2. The adjustable shutter of any of paragraphs A3-A6.1, wherein the first louver magnetic coupling element is attached to a first location on the front edge region, and the second louver magnetic coupling element is attached to a second location on the front edge region, wherein the first location is spaced apart from the second location.

A7. The adjustable shutter of any of paragraphs A3-A6.2, wherein each louver magnetic coupling element corresponds to a magnetic element embedded within one of the front edge region, the first side edge region, or the second side edge region of the corresponding louver.

A8. The adjustable shutter of paragraph A6 or A7, wherein each louver magnetic coupling element corresponds to an elongated magnetic element, and the elongated magnetic element extends along a length of one of the front edge region, the first side edge region, or the 1.0 second side edge region of the corresponding louver.

A9. The adjustable shutter of paragraph A8, wherein each rod magnetic coupling element is configured to, while remaining magnetically coupled to a corresponding elongated magnetic element, slide along the length of one of the front edge region, the first side edge region, or the second side edge region of a corresponding louver in response to an additional imparted translational adjustment to the louver adjustment rod.

A10. The adjustable shutter of any of paragraphs A1-A9, wherein each louver of the plurality of louvers includes a recess that receives at least a portion of the louver adjustment rod, and wherein a corresponding louver magnetic coupling element is located proximate to the recess such that the corresponding louver magnetic coupling element magnetically couples to a corresponding rod magnetic coupling element.

A11. The adjustable shutter of any of paragraphs A1-A10, wherein the louver adjustment rod includes a plurality of rod magnetic coupling elements, and further wherein each rod magnetic coupling element corresponds to a magnetic element attached to a location on a surface of the louver adjustment rod.

A12. The adjustable shutter of any of paragraphs A1-A10, wherein the louver adjustment rod includes a plurality of rod magnetic coupling elements, and further wherein each rod magnetic coupling element corresponds to a magnetic element embedded within the louver adjustment rod.

A13. The adjustable shutter of paragraph A11 or A12, wherein the louver adjustment rod includes the plurality of rod magnetic coupling elements, and further wherein the one or more rod magnetic coupling elements are spaced apart along the louver adjustment rod.

A14. The adjustable shutter of any of paragraphs A1-A11, wherein each of the rod magnetic coupling elements comprises a magnetic material configured to magnetically couple the plurality of louver magnetic coupling elements concurrently.

A15. The adjustable shutter of any of paragraphs A1-A14, wherein the louver adjustment rod includes the recess configured to accept at least a portion of the louver of the plurality of louvers, and wherein the corresponding rod magnetic coupling element is located proximate to the recess such that the corresponding rod magnetic coupling element magnetically couples to the corresponding louver magnetic coupling element when the at least a portion of the corresponding louver is positioned in the recess.

A16. The adjustable shutter of any of paragraphs A1-A15, wherein the adjustable window shutter further includes a support louver that is mechanically coupled to the louver adjustment rod.

A16.1. The adjustable shutter of paragraph A16, wherein the support louver further includes a louver magnetic coupling element, and wherein the plurality of louvers includes the support louver.

A17. The, adjustable shutter of any of paragraphs A1-A16.1, the louver magnetic coupling element and the rod magnetic coupling element are configured to maintain magnetic coupling through a full pivotal range of the adjustable window shutter.

A17.1. The adjustable shutter of any of paragraphs A1-A17, wherein one of the louver magnetic coupling element and the rod magnetic coupling element are arcuate.

A17.2. The adjustable shutter of paragraph A17.1, wherein both the louver magnetic coupling element and the rod magnetic coupling element are arcuate.

A17.3. The adjustable shutter of any of paragraphs A1-A17.2, wherein the full pivotal range of the adjustable window shutter includes a first closed orientation of the plurality of louvers in a first rotational direction and a second closed orientation of the plurality of the louvers in a second rotational direction, wherein the first rotational direction opposes the second rotational direction.

A18. The adjustable shutter of any of paragraphs A1-A17, wherein the louver magnetic coupling element comprises a magnet material.

A19. The adjustable shutter of any of paragraphs A1-A17, wherein the louver magnetic coupling element comprises a permanent magnet material.

A20. The adjustable shutter of paragraph A19, wherein each rod magnetic coupling element comprises a magnetic material.

A21. The adjustable shutter of paragraph A20, wherein each rod magnetic material is a permanent magnet material.

A22. The adjustable shutter of any of paragraphs A1-A21, wherein each louver of the plurality of louvers is coupled for pivotal rotation relative to the frame.

A23. The adjustable shutter of any of paragraphs A1-A22, wherein each louver of the plurality of louvers is pivotally attached to the frame via one or more pivot joints.

A24. The adjustable shutter of any of paragraphs A1-A23, wherein the frame is configured to be attached to a window frame of a window.

A25. The adjustable shutter of any of paragraphs A1-A24, wherein the plurality of louvers are configured to obscure an amount of light incident on the adjustable window shutter, and wherein the amount of light obscured by the adjustable window shutter is relationally dependent upon the angular position of each louver of the plurality of louvers about its corresponding pivot axis.

A26. The adjustable shutter of any of paragraphs A1-A25, wherein the plurality of louvers is positioned in a vertical arrangement.

A27. The adjustable shutter of any of paragraphs A1-A25, wherein the plurality of louvers is positioned in a horizontal arrangement.

A28. The adjustable shutter of any of paragraphs A1-A27, wherein the pivot axes of each louver of the plurality of louvers are parallel.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, “at least substantially,” when modifying a degree or relationship, includes not only the recited “substantial” degree or relationship, but also the full extent of the recited degree or relationship. For example, an object that is at least substantially parallel to a second object includes objects that are substantially parallel to the second object and also includes objects that are parallel to the second object.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An adjustable shutter, comprising:
a frame;
a plurality of louvers coupled for pivotal rotation relative to the frame;
wherein each louver of the plurality of louvers is:
configured to be rotated about a pivot axis of a corresponding louver, and
comprises a louver magnetic coupling element;
a louver adjustment rod including at least one rod magnetic coupling element magnetically coupled to the louver magnetic coupling element of the plurality of louvers; and
wherein louver adjustment rod is configured to receive an imparted translational adjustment, and wherein responsive to receipt of the imparted translational adjustment, the louver adjustment rod causes each of the plurality of louvers to pivot about its respective pivot axis.

2. The adjustable shutter of claim 1, wherein each louver magnetic coupling element is configured to cause the corresponding louver of the plurality of louvers to:
pivot about the pivot axis of the corresponding louver in a first pivot direction in correspondence with a first imparted translational adjustment to the louver adjustment rod in a first translational direction, and
pivot about the pivot axis of the corresponding louver in a second pivot direction in correspondence with a second imparted translational adjustment to the louver adjustment rod in a second translational direction, wherein the first pivot direction opposes the pivot direction.

3. The adjustable shutter of claim 1, wherein each louver magnetic coupling element is configured to maintain a magnetic coupling with a corresponding rod magnetic coupling element of the one or more rod magnetic coupling elements across a full range of pivotal movement of the louvers, wherein the full range of pivotal movement includes a first closed orientation of the plurality of louvers in a first rotational direction and a second closed orientation of the plurality of the louvers in a second rotational direction, and wherein the first rotational direction opposes the second rotational direction.

4. The adjustable shutter of claim, wherein the louver adjustment rod includes a plurality of rod magnetic coupling elements, and wherein the plurality of rod magnetic coupling elements are spaced apart along the louver adjustment rod, such that when coupled to corresponding louver magnetic coupling elements, each louver of the plurality of louvers has a substantially similar pivot position.

5. The adjustable shutter of claim 1, wherein each of the at least one rod magnetic coupling elements is a socket element having a concave receiving surface, and each louver magnetic coupling element has ball shape configured to maintain a rolling magnetic connection with the concave receiving surface of a corresponding rod magnetic coupling element.

6. The adjustable shutter of claim 1, wherein each of the plurality of louvers includes a front edge region, and wherein each louver magnetic coupling element is included in the front edge region of a corresponding louver.

7. The adjustable shutter of claim 6, wherein each louver magnetic coupling element is attached to a location on the front edge region of the corresponding louver.

8. The adjustable shutter of claim 6, wherein each louver magnetic coupling element is embedded within the front edge region of the corresponding louver.

9. The adjustable shutter of claim 1, wherein each louver magnetic coupling element is arcuate.

10. The adjustable shutter of claim 7, wherein each rod magnetic coupling element of the one or more rod magnetic coupling elements is arcuate.

11. The adjustable shutter of claim 1, wherein each louver of the plurality of louvers includes a first side edge region and a second side edge region opposite the first side edge region and wherein each louver magnetic coupling element is included in one of the first side edge region and the second side edge region of the corresponding louver of the plurality of louvers.

12. The adjustable shutter of claim 10, wherein each of the at least one rod magnetic coupling elements is a socket element having a concave receiving surface, and each louver magnetic coupling element has a convex shape configured to maintain a rolling magnetic connection with the concave receiving surface of a corresponding rod magnetic coupling element.

13. The adjustable shutter of claim 1, wherein each louver of the plurality of louvers includes at least:
a first louver magnetic coupling element associated with a first attachment position of the louver adjustment rod relative to the corresponding louver;
a second louver magnetic coupling element associated with a second attachment position of the louver adjustment rod relative to the corresponding louver; and
wherein the louver adjustment rod is configured to be selectively magnetically coupled to the first louver magnetic coupling element when in the first attachment position, and the second louver magnetic coupling element when in the second attachment position.

14. The adjustable shutter of claim 1, wherein the adjustable shutter further includes a support louver that is mechanically coupled to the louver adjustment rod.

15. The adjustable shutter of claim 13, wherein the support louver further includes a louver magnetic coupling element, and wherein the plurality of louvers includes the support louver.

16. The adjustable shutter of any of claim 1, wherein at least one louver magnetic coupling element corresponds to an elongated magnetic element, and the elongated magnetic element extends along an edge region of the corresponding louver of the plurality of louvers.

17. The adjustable shutter of any of claim 16, wherein the at least rod magnetic coupling element is configured to, while remaining magnetically coupled to the elongated magnetic element, slide along the edge region of the corresponding louver in response to an additional imparted translational adjustment to the louver adjustment rod.

18. The adjustable shutter of claim 1, wherein each louver of the plurality of louvers includes a recess that receives at least a portion of the louver adjustment rod, and wherein a corresponding louver magnetic coupling element is located proximate to the recess such that the corresponding louver magnetic coupling element magnetically couples to a corresponding rod magnetic coupling element.

19. The adjustable shutter of claim 1, wherein the louver adjustment rod includes a plurality of rod magnetic coupling elements and each of the plurality of rod magnetic coupling elements corresponds to a magnetic element embedded within the louver adjustment rod.

20. The adjustable shutter of claim 1, wherein the at least one rod magnetic coupling element comprises a magnetic material configured to magnetically couple to a plurality of louver magnetic coupling elements concurrently.

21. The adjustable shutter of claim 1, wherein the louver adjustment rod includes a plurality of rod magnetic coupling elements, wherein the louver adjustment rod includes a recess configured to accept at least a portion of a louver of the plurality of louvers, and wherein a corresponding rod magnetic coupling element of the plurality of rod magnetic coupling elements is located proximate to the recess such that the corresponding rod magnetic coupling element magnetically couples to a corresponding louver magnetic coupling element when the at least a portion of the corresponding louver is positioned in the recess.
